(19) United States
(12) Patent Application Publication
(10) Pub. No.: US 2024/0199390 A1
(43) Pub. Date: Jun. 20, 2024

(54) REMOTE AND BATTERY-POWERED HOISTING DEVICE

(71) Applicant: Alexandre Archambault, Montreal (CA)

(72) Inventor: Alexandre Archambault, Montreal (CA)

(21) Appl. No.: 18/553,687

(22) PCT Filed: Apr. 5, 2022
(86) PCT No.: PCT/CA2022/050512

§ 371 Date: Oct. 2, 2023

Related U.S. Application Data
(60) Provisional application No. 63/200,988, filed on Apr. 7, 2021.

(51) Int. Cl. B66D 1/74; A63C 11/10

(52) U.S. Cl. CPC B66D 1/7426; A63C 11/10; B66D 1/7484; B66D 1/7489

(57) ABSTRACT

A portable hoisting device configured to be connected to a cable secured to a destination location for hoisting at least one person from a start location to the destination location is provided. The device includes a winch mechanism having a drum body shaped and adapted to have the cable wrap around the drum body. The winch mechanism is operable to selectively wrap the cable around the drum body. The device has a gear train operatively connected to the drum body and operable to engage the drum body in rotation, a motor operatively connected to the gear train, a control assembly operatively connected to the motor to control same, and a latching assembly adapted to enable a load to be connected to a component of the portable hoisting device, wherein the control assembly comprises a remote control configured to send signals to the motor remotely.

### TECHNICAL FIELD

The technical field generally relates to hoisting devices and systems for hoisting a load, and more particularly a portable and battery-powered hoisting devices.

### BACKGROUND

Gaining access to the backcountry can be arduous, limited and complex. Without very expensive equipment such as a snowmobile which includes a limited number or riders, a snowcat which is relatively expensive, or a helicopter which is even more expensive, skiers and snowboarders are usually left to explore the backcountry on foot, with climbing skins under their skis or split boards.

Therefore, there remains a need for devices and/or systems that allow for quick and convenient access to hills and mountainsides to enjoy winter sports, such as skiing and snowboarding, among others, and which, by virtue of their designs and components, would be able to overcome or at least minimize some of the above-discussed concerns.

### SUMMARY

According to an aspect of the present disclosure, a portable hoisting device configured to be connected to a cable secured to a destination location for hoisting at least one person from a start location to the destination location is provided. The portable hoisting device includes an enclosure; a drum assembly rotatably mounted to the enclosure. The drum assembly having a drum body having an elongated portion shaped and adapted to have the cable wrap around the drum body; and a drum head mounted to the drum body opposite the enclosure, the drum head having a tensioning mechanism adapted to maintain the second end of the cable under tension. The portable hoisting device also includes a gear train at least partially housed within the enclosure and the drum body, and comprising a transmission gear operatively connected to the drum body and operable to engage the drum body in rotation for wrapping and unwrapping the cable from the drum body; a motor operatively connected to the gear train to engage the transmission gear in rotation; a control assembly operatively connected to the motor to control same; a latching assembly adapted to enable the at least one person to be connected to the enclosure, wherein rotation of the drum assembly wraps a first end of the cable around the drum body and unwraps and pays out a second end of the cable for hoisting the at least one person toward the destination location.

According to a possible embodiment, the control assembly comprises an electronic speed controller (ESC) operatively connected to the motor for controlling same, and a power source operatively connected to the ESC to supply power thereto and being in data communication with a command transceiver to receive a control signal therefrom.

According to a possible embodiment, the power source is a battery pack.

According to a possible embodiment, the control assembly comprises a remote control configured to send signals to the command transceiver and control the ESC remotely.

According to a possible embodiment, the control assembly is connectable to the motor via wires.

According to a possible embodiment, the portable hoisting device further includes a control assembly compartment adapted to house at least one of the battery pack, the ESC and the remote control, and wherein the control assembly compartment is adapted to be transported by or on the person to enable remote operation of the motor.

According to a possible embodiment, the control assembly further comprises a battery management system (BMS) provided within the control assembly compartment and configured to monitor the state of the battery pack.

According to a possible embodiment, the BMS is configured to monitor at least one of a voltage, a current, a temperature and a coolant flow.

According to a possible embodiment, the battery pack comprises at least one of a 4S battery, a 6S battery, 12S battery, a 18S battery or a combination thereof.

According to a possible embodiment, the motor has a KV output of between about 50 KV and about 250 KV.

According to a possible embodiment, the enclosure comprises a shaft, and wherein the drum body comprises a drum body shell having a bore therethrough for receiving the shaft, and wherein the cable is adapted to be wrapped around the drum shell.

According to a possible embodiment, the drum body shell comprises a bottom end operatively coupled to the gear train, and a top end opposite the bottom end, and wherein the drum body shell is shaped and adapted to prevent the portion of cable wrapped around it from being released through the bottom end and the top end thereof.

According to a possible embodiment, the gear train comprises a plurality of transmission gears adapted to define a planetary gear assembly, and wherein the bottom end of the drum body shell comprises an internal gear configured to engage the planetary gear assembly.

According to a possible embodiment, the gear train comprises a pair of driver gears coupled to the transmission gear, and wherein the motor comprises a pair of driving motors operatively connected to the driver gears.

According to a possible embodiment, the gear train defines a gear ratio between about 4:1 and about 25:1.

According to a possible embodiment, the latching assembly comprises a clip secured to the enclosure or drum body, the clip being adapted to have a strap attached thereto, the strap having a free end adapted to be attached to the person.

According to another aspect of the present disclosure, a portable hoisting device configured to be connected to a cable is provided. The portable hoisting device includes a winch mechanism having a drum body being shaped and adapted to have a portion of the cable wrap around the drum body, the winch mechanism being operable to selectively wrap the cable around the drum body; a gear train comprising a transmission gear operatively connected to the drum body and operable to engage the drum body in rotation; a motor operatively connected to the gear train to engage the transmission gear in rotation; a control assembly operatively connected to the motor to control same; and a latching assembly adapted to enable a load to be connected to a component of the portable hoisting device, wherein the control assembly comprises a remote control configured to send signals to the motor remotely.

According to a possible embodiment, the power source is a battery pack.

According to a possible embodiment, the control assembly is connectable to the motor via wires.

According to a possible embodiment, the winch mechanism is a self-tailing winch mechanism operable to feed a first end of the cable to the drum body and simultaneously pay out a second end of the cable.

According to yet another aspect of the invention, there is also provided a method of assembling components of the above-mentioned apparatus.

According to yet another aspect of the invention, there is also provided a method of using the above-mentioned apparatus, and/or component(s) thereof.

According to yet another aspect of the invention, there is also provided a kit with components for assembling the above-mentioned apparatus.

According to yet another aspect of the present invention, there is also provided a set of components for interchanging with components of the above-mentioned kit.

According to yet another aspect of the present invention, there is also provided a method of assembling components of the above-mentioned kit and/or set.

The objects, advantages, and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a perspective view of a hoisting device, according to an embodiment.

FIG. 2 is a side elevation view of the hoisting device shown in FIG. 1, showing an enclosure having a cylindrical drum body portion mounted to an enclosure and a motor assembly, according to an embodiment.

FIG. 3 is an enlarged view of a drum head coupled to the cylindrical drum body shown in FIG. 2, showing a cable guide and a tensioning mechanism, according to an embodiment.

FIG. 4 is an exploded top perspective view of the hoisting device shown in FIG. 1, showing a gear train coupled to the motor assembly and enclosable within the drum body, according to an embodiment.

FIG. 5 is an exploded perspective view of the hoisting device shown in FIGS. 1 and 4, showing a planetary gear assembly of the gear train, according to an embodiment.

FIG. 5A is an enlarged view of the planetary gear assembly shown in FIG. 5, showing a sun gear coupled between a plurality of planet gears, according to an embodiment.

FIG. 6 is a exploded bottom perspective view of the hoisting device shown in FIG. 1, showing an internal gear hub provided within the drum body, according to an embodiment.

FIG. 6A is an enlarged view of the internal gear hub shown in FIG. 6, according to an embodiment.

FIG. 7 is a bottom perspective view of the hoisting device shown in FIG. 1, showing the motor assembly having a pair of driving motors, according to an embodiment.

FIG. 8 is a side view of an illustration showing the hoisting device connected to a tree and coupled to a skier for hoisting the skier toward the tree, according to an embodiment.

FIG. 9 is a schematic view of a control assembly of the hoisting device, showing a remote-controlled motor assembly, according to an embodiment.

### DETAILED DESCRIPTION

As will be explained below in relation to various embodiments, the present disclosure describes a hoisting device (which can also be referred to simply as a “lift”, a “hoist”, a “device” or an “apparatus”) for assisting a person, or group of people, in going up a mountain, or across any given terrain, is provided. More particularly, the hoisting device can include a portable, motorized and remote-operated winch mechanism configured to enable hoisting at least one person along a flat, or an inclined surface, such as a hill or a mountainside. The device can be useful for hoisting a person or a group of people atop a hill to participate in certain sports, such as skiing or snowboarding, for example and among others, in a simpler, easier, faster, more accurate, more effective, more functional, more reliable and/or more versatile manner than what is possible with other conventional devices and/or apparatus.

The portable hoisting device can be configured to be connected to a cable secured at a first end thereof to a destination location, such as a mountaintop, and extending down the mountainside to a more accessible starting location, such as near a cabin or in a clearing, although other locations are possible, such as in the middle of a forest, for example. Once the hoisting device is connected to the cable, one or more person can attach themselves to the hoisting device provided with the winch mechanism operable to wrap the cable around a portion thereof for hoisting the one or more person up the mountainside and toward the destination location. In accordance with a non-limitative embodiment, the portable hoisting device includes a transmission, or gear train, coupled to the winch mechanism, and a motor operatively connected to the gear train. Therefore, it is noted that operation of the motor engages the gear train in rotation, which in turn engages the drum of the winch mechanism for pulling the load, i.e., the one or more person, up the cable, and thus up the mountainside.

As will be described further below, the hoisting device comprises a control assembly operatively connected to the motor to control its speed. The control assembly can include an electronic speed controller (ESC) operatively connected to the motor, and a power source connected to the ESC to supply power thereto. The power source is also in data communication with a command transceiver to receive a control signal therefrom, thereby enabling remote control of the motor, and thus of the hoisting device as a whole. It is therefore noted that a person connected to the hoisting device can selectively control the speed at which he or she wishes to travel along the cable in order to reach the destination location.

In the embodiment described below, the hoisting device is described as being configured to hoist a load along an incline, such as a hill or a mountain. However, it is appreciated that it can be used to travel distances along substantially flat areas, for example, to access remote locations or tourist location in a mountain range. It should also be understood that, in the context of the present disclosure, the load being hoisted is a person, or a group of people. However, it is appreciated that any other loads can be hoisted using the hoisting device described herein, such as various supplies, food, medical equipment, tools, clothes, etc., to remote and difficult to access locations.

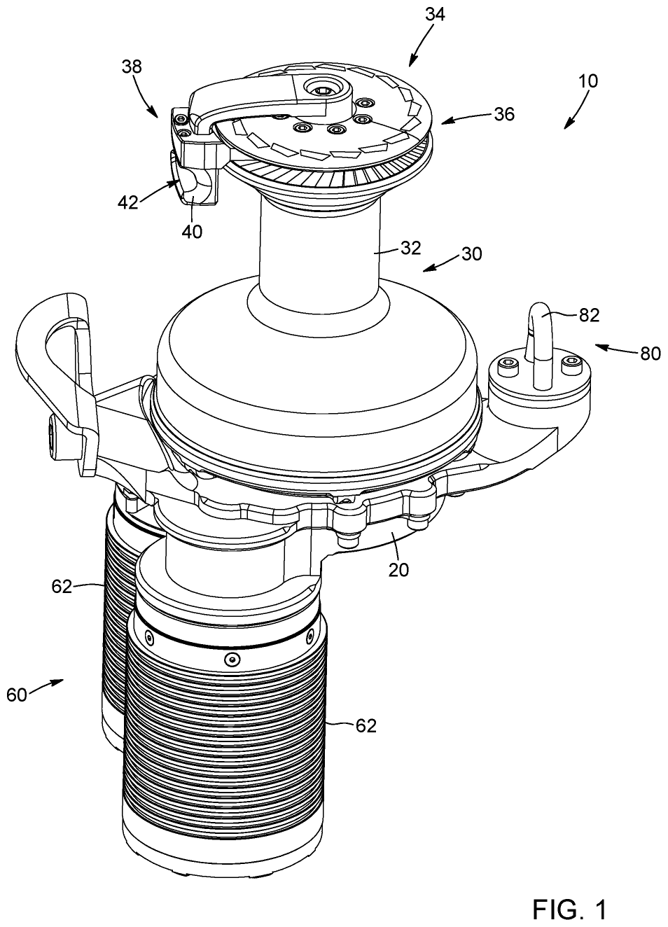

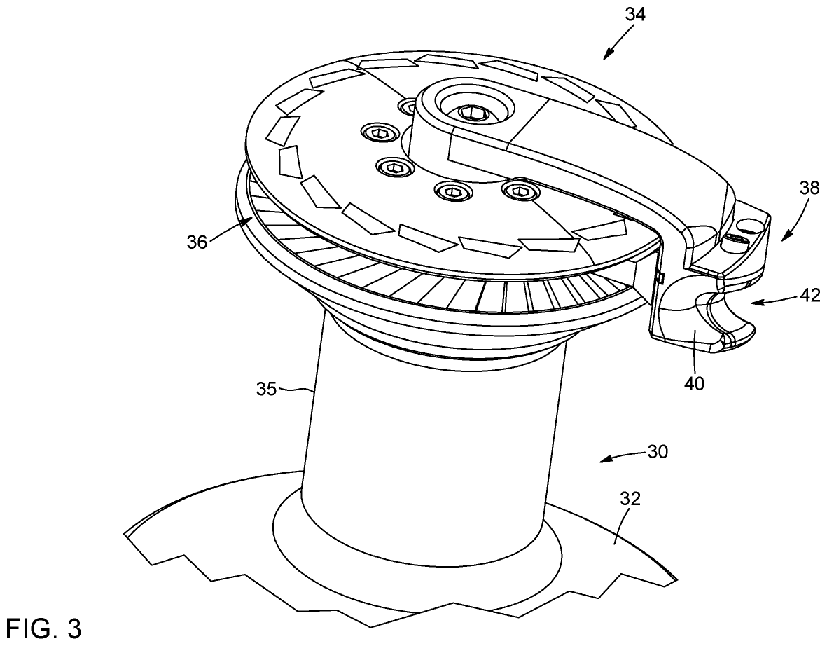

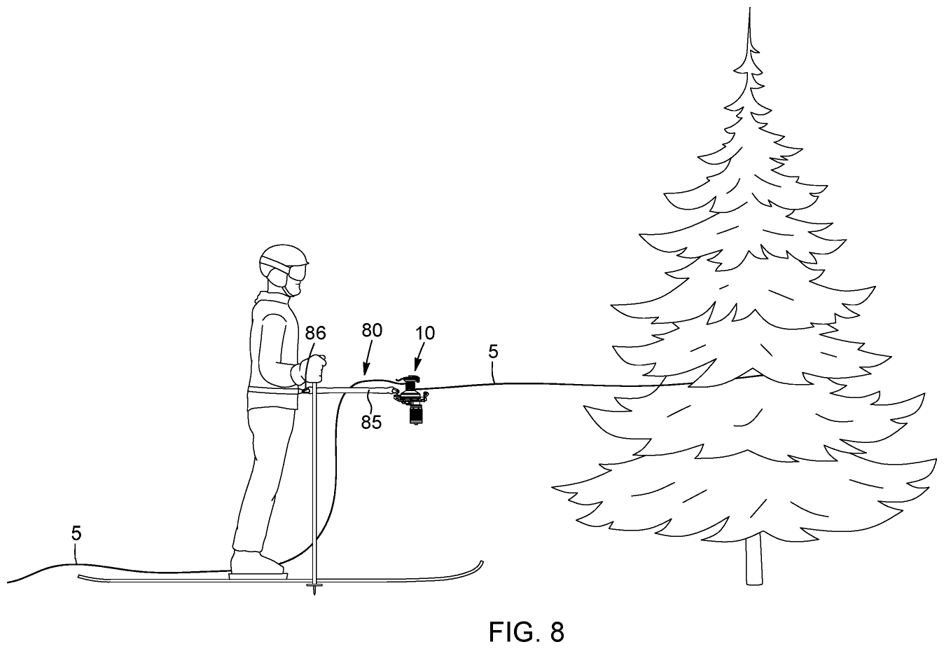

Referring to FIGS. 1 to 3, a portable hoisting device 10 configured to be connected to a cable 5 (seen in FIG. 8) for hoisting a load, such as and without being limitative, a person along the cable in accordance with a possible embodiment is shown. The hoisting device 10 includes a main body, or enclosure 20, to which the load can be connected to, as will be described further below. The hoisting device 10 also has a drum assembly 30 rotatably coupled to the enclosure 20 such that one or more components of the drum assembly 30 can rotate relative to the enclosure 20. In this embodiment, the drum assembly 30 has a drum body 32 shaped and adapted to have a portion of the cable wrap around it. The drum body 32 preferably includes an elongated portion having a generally cylindrical shape to allow the cable to wrap therearound multiple times. In some embodiments, the shape and size of the drum body 32 enables the cable to wrap around the elongated portion multiple times without overlapping itself.

It is noted that the cable may be required to be wrapped around the drum body 32 prior to operating the hoisting device 10. For instance, the cable can be wrapped between 3 to 6 times around the drum body 32, but can be wrapped more times (e.g., 10 or more times). Once the cable is wrapped, rotating the drum will cause the first end of the cable to further wrap around the drum body 32, and allow the second end of the cable to unwrap, thereby hoisting the load connected to the hoisting device 10 along the cable. In other words, rotating the drum body 32 both winds up and pays out the cable.

Still referring to FIGS. 1 to 3, the drum assembly 30 further comprises a drum head 34 mounted to the drum body 32. As seen in FIG. 1, the drum head 34 can be coupled to the drum body 32 opposite the enclosure 20, although other configurations are possible. The drum head 34 can be provided with a tensioning mechanism 36 adapted to maintain the second end of the cable under tension, therefore preventing the second end of the cable from slipping off the drum while it unwraps during operation of the device 10. In other words, the tensioning mechanism 36 facilitates paying out the cable from the drum body 32 during hoisting operations. It is noted that the drum assembly 30 can include a self-tailing winch mechanism configured to pull a load (e.g., a person) and prevent the cable from slipping from around the drum body via the tensioning mechanism. Self-tailing winch mechanisms are well known and will not be described further.

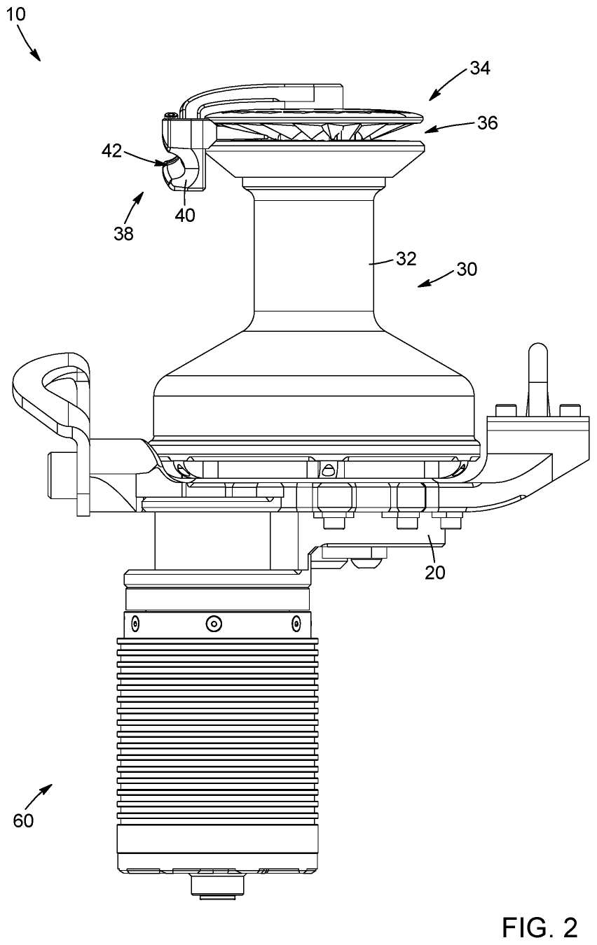

In some embodiments, the drum head includes a cable guide 38 configured to facilitate unwinding the cable from around the drum body 32 and feeding the cable to the tensioning mechanism 36. As illustrated, the cable guide 38 can have a substantially “half-pipe shaped” head 40 defining a groove 42 adapted to receive the cable therein. As seen in FIG. 2, the head 40 of the cable guide 38 can be positioned along an outer surface of the drum body 32 and/or drum head 34, and be positioned at a transition between the drum body and drum head. As such, running the cable from the drum body 32 and into the tensioning mechanism 36 of the drum head 34 is facilitated by the transition provided via the cable guide 38.

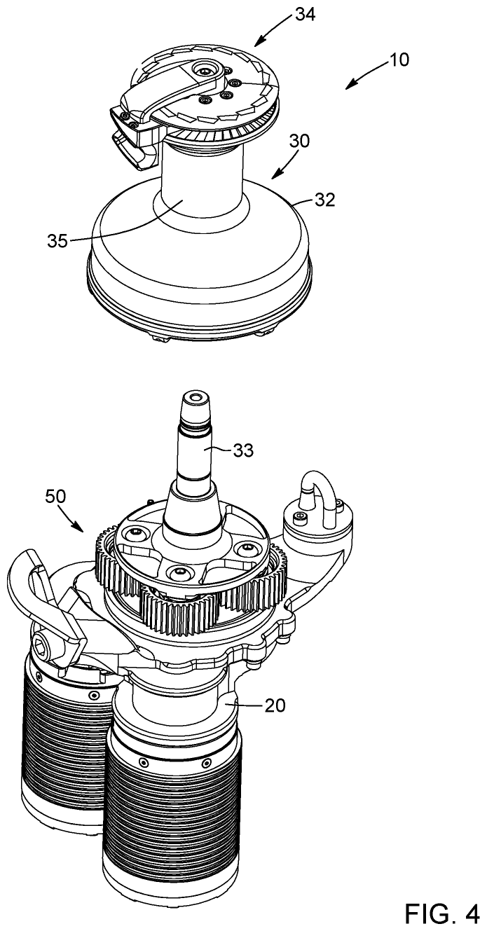

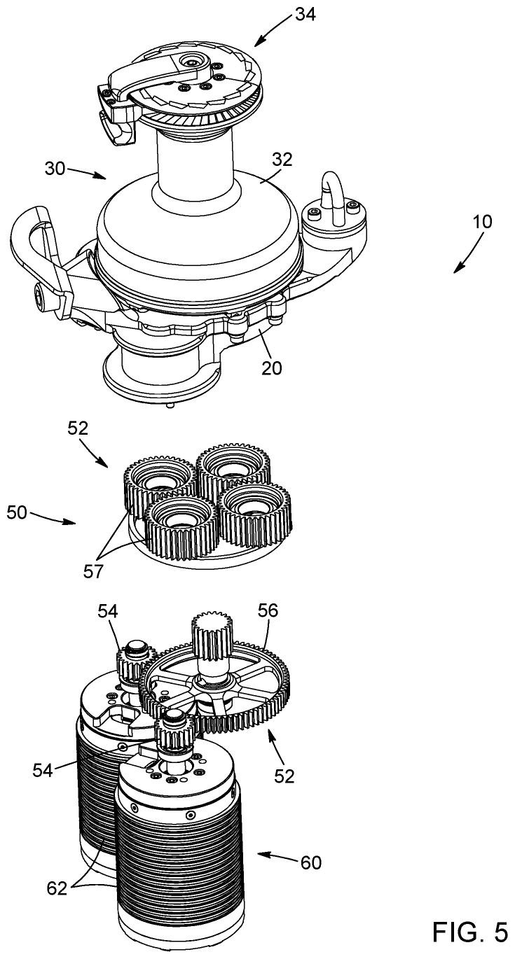

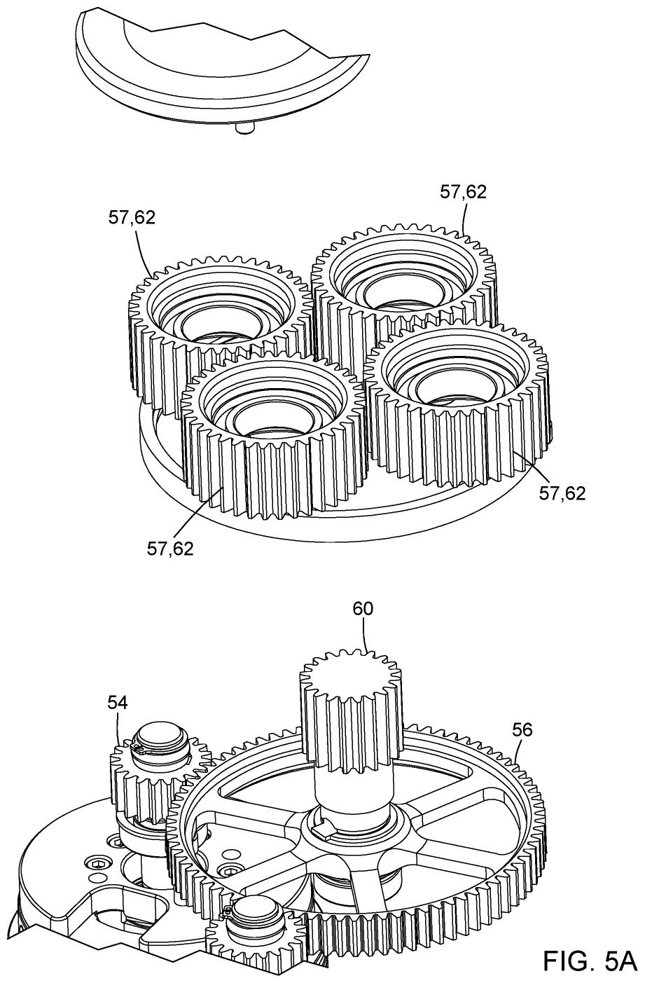

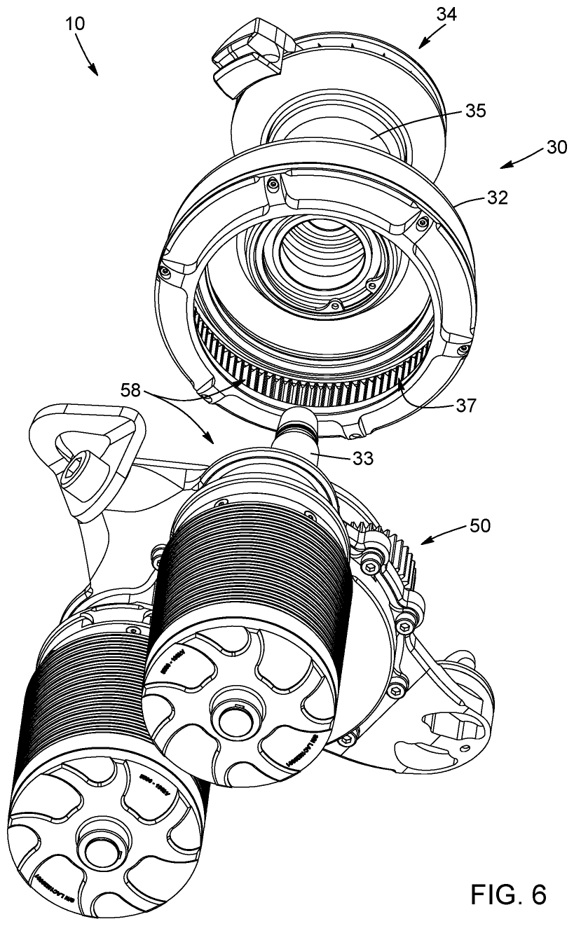

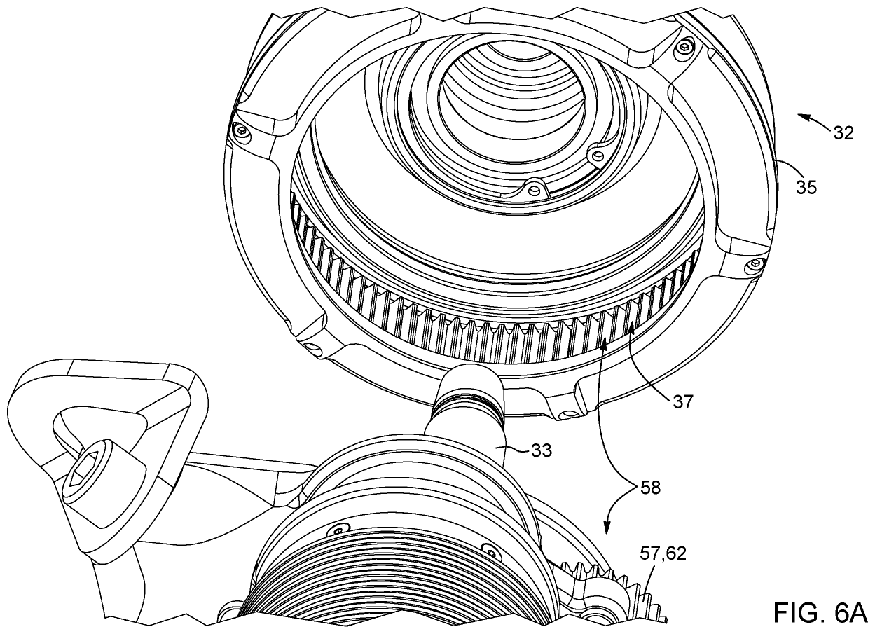

Now referring to FIGS. 4 to 6A, in addition to FIGS. 1 to 3, the portable hoisting device 10 comprises a gear train 50 adapted to be housed within the enclosure 20, the drum body 32 or a combination thereof. In this embodiment, the gear train 50 includes one or more transmission gears 52 operatively connected between a motor 70 and the drum assembly 30 for engaging it in rotation for wrapping/winding and unwrapping/unwinding the cable from the drum body 32. As illustrated in FIG. 4, the enclosure 20 and the drum assembly 30 can cooperate to enable the drum assembly 30 to connect to the gear train 50 (e.g., to the one or more transmission gears 52). In some embodiments, one of the enclosure and the drum body 32 comprises a shaft 33, with the drum body also comprising a drum body shell 35 having a bore therethrough for receiving the shaft 33 and at least partially blocking radial movement of the drum shell 35. It is noted that the cable is adapted to be wrapped around the body drum shell 35. In this embodiment, the enclosure 20 has a bottom portion connected to the motor assembly 70 and includes the shaft 33 which extends through the drum body shell 35 to engage the drum head 34.

In some embodiments, the drum body shell 35 is adapted to be coupled to the transmission gear 52 such that engaging the transmission gear 52 in rotation correspondingly engages the drum shell 35 in rotation. In this embodiment, the drum body shell 35 is adapted to be connected to the transmission gears 52 via any suitable connection methods, such as via a key slot connection, for example. In some embodiments, the transmission gear 52 can include one or more detents, and the drum body shell 35 includes complementarily-shaped keys configured to cooperate and engage the detents of the transmission gear(s) 52 such that movement of one of these components engages the other one correspondingly.

In this embodiment, the drum body shell 35 includes an internal gear hub 37 configured to engage the transmission gear(s) 52. It should be noted that operating the motor of the device engages the transmission gear(s) 52 in rotation, which in turn engages the drum body shell 35 in rotation via the connection to the internal gear hub 37. During rotation of the drum body shell 35, the shaft 33 is adapted to remain generally locked in position (e.g., the shaft 33 does not rotate), such that the drum body shell 35 rotates about the shaft 33. However, it is appreciated that other configurations are possible, such as permitting the shaft to at least partially rotate within the shell 35, for example. In some embodiments, the transmission gears 52 include a primary driven gear 56 and one or more driver gears 54. In the illustrated embodiment, the gear train 50 comprises a pair of driver gears 54 engaged with the primary driven gear 56, such that rotation of the driver gears 54 effects rotation of the primary driven gear 56.

The gear train 50 can include one or more secondary driven gears 57 adapted to operatively connect the primary driven gear 56 to the drum body shell 35. Alternatively, the primary driven gear 56 can be operatively coupled to the drum body shell 35, such as directly to the internal gear hub 37, for example. In this embodiment, the gear train 50, in combination with the drum body shell 35, can define a planetary gear assembly 58. For instance, the primary driven gear 56 can include a central gear 60, or “sun gear”, configured to engage the secondary driven gears 57, corresponding to planet gears 62 of the planetary gear assembly 58. The planet gears 62 are configured to engage the internal gear hub 37, or “ring gear”, to engage the drum body shell 35 in rotation.

It should be understood that the gear train 50 can have any suitable configuration. For example, the gear train 50 can include a single-stage gearbox, a two-stage gear box, a planetary gear configuration (as described above), or any other suitable configuration or combination thereof. It should be noted that adding gears (e.g., driver gears, idler gears and/or driven gears) can increase the torque generated by the hoisting device 10. However, adding gears can also increase the size and/or the weight of the device, which can become more cumbersome (e.g., larger and/or heavier) and thus harder to transport. In some embodiments, the gears of the gear train 50 can each be installed in a common plane, although other configurations are possible, such as a multi-stage gear drive having gears on a plurality of planes.

In preferred embodiments, the gear train 50 defines a gear ratio of between 4:1 to 25:1, such as 20:1, such as 7:1, although other configurations are possible. The gear train can be designed to provide a desired, or required, gear ratio capable of hoisting any given load. For example, the gear ratio can be defined depending on the number of people who will be hoisted up the mountain at any given time. Additionally, or alternatively, the gear ratio can be defined based on the speed at which the load is required to be hoisted to the destination location, or based on the incline of the terrain between the starting location and the destination location.

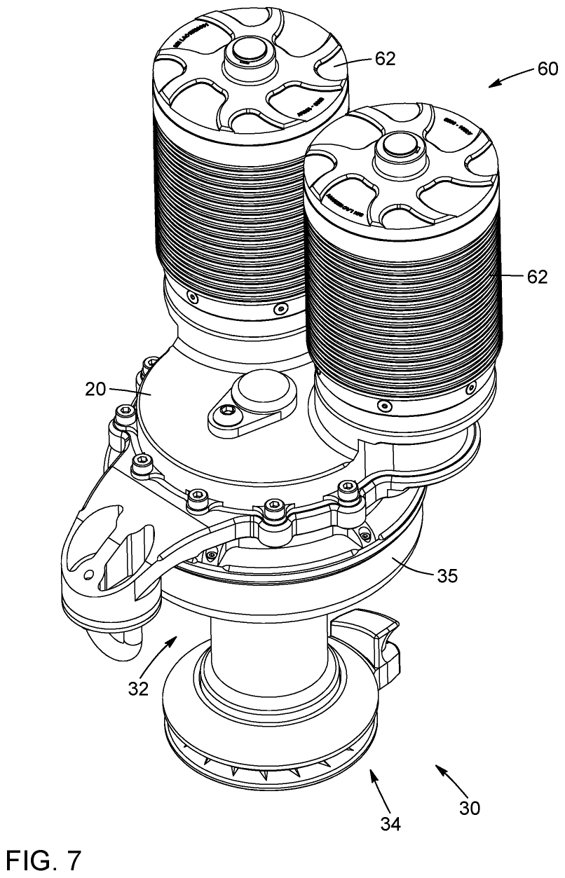

Referring broadly to FIGS. 1 to 7, the hoisting device 10 includes a motor 70 operatively connected to the gear train 50 for engaging the gears (e.g., the driver and driven gears, the planetary gear assembly, etc.) to ultimately engage the drum body shell 35 in rotation. Specifically, the motor 70 can include any suitable number of driving motors 72, such as two, for example, whereby each driving motor 72 is connected to one of the driver gears 54. The driver motors 72 can include outrunner motors of various sizes, although other configurations and types of motors are possible, such as inrunner motors, for example. It is noted that the motors can vary in KV output, such as between about 70 KV and about 220 KV, depending on the torque required, the number of riders being pulled and the speed at which they want to climb. One, two, three or more motors can be installed on the device 10, again depending on the number of riders to climb, the speed to be achieved and/or the steepness of the slope to be climbed.

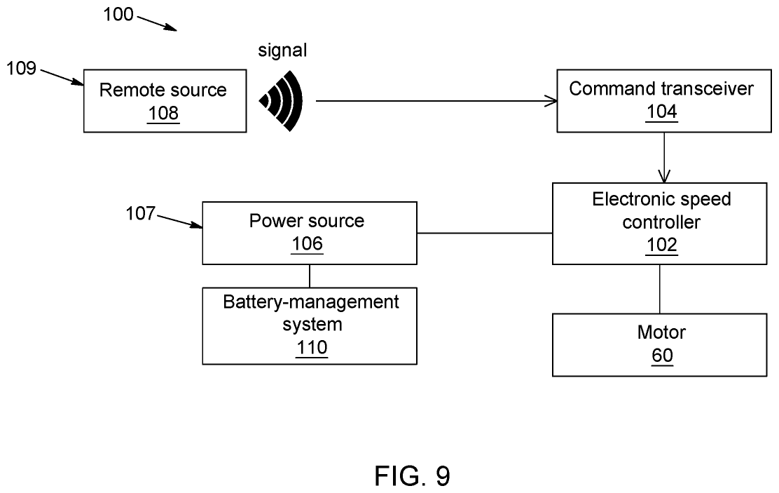

Now referring to FIG. 9, the hoisting device further includes a control assembly 100 operatively connected to the motor 70 to remotely control the operation of the motor 70. More specifically, the control assembly 100 can include an electronic speed controller (ESC) 102, a command transceiver 104 and a power source 106, such as a battery pack 107, for example. In this embodiment, the ESC 102 is adapted to control the speed at which the motor 70 operates, effectively regulating the speed at which the cable winds and unwinds about the drum body shell, and therefore controls the speed of the load being hoisted. Furthermore, the ESC 102 is in data communication with the command transceiver 104 and controls the motor 70 via a control signal transmitted from said command transceiver 104 It should be understood that the power source 106 is configured to supply power to the ESC 102 in order to operate the motor 70.

In the present embodiment, the command transceiver 104 is adapted to acquire the control signal from a remote source 108 and transmit said signal to the ESC 102. In some embodiments, the remote source 108 includes a remote control 109 adapted to be transported or worn by the user (e.g., the person being hoisted). As such, the person in control of the control assembly 100 effectively controls the speed at which he or she (and/or the group of people or objects connected to the device) ascends the mountainside, for example. In this embodiment, the electronics of the control assembly 100 (e.g., the battery pack 107, the ESC 102, the remote control 109, etc.) can be provided within a compartment which can be transported by the user, for example, in a backpack or in a separate bag connected to the hoisting device. It is noted that the electronics can be connected to the motor(s) via any suitable method, such as via wires, or via a wireless connection. As such, once the user as been hoisted to the destination location, the wires can be disconnected from the motor(s), thereby allowing the device to go backwards along the cable (e.g., down the mountainside) to allow another person or group of people, to be hoisted. Alternatively, in some embodiments, the electronics can be provided within the enclosure 20, or coupled thereto in any suitable manner. The control assembly 100 can further include a battery-management system 110, which can be contained within the compartment. It is understood that the battery-management system 110 is configured to monitor the battery for performance issues and upkeep purposes, among others. In some embodiments, the battery pack can include any suitable battery, such as any one of a 4S, a 6S (22.2V nominal), 12S (44.4V) and 18S (66.6V), or a plurality or combination thereof. It should be noted that by changing gear ratios, battery voltage and/or motor KV, any number of users, such as between two (2) and six (6) people, or more, can be hoisted on a relatively small battery pack (e.g., 12s2p to 18s4p—Molicel P42A) up an incline between about 0% and about 60% grade, for example.

Referring back to FIG. 1, in addition to FIG. 8, the hoisting device 10 can include a latching assembly 80 configured to allow a load to be connected to the device 10 such that operating the device effectively hoists the load along the cable. In this embodiment, the latching mechanism 80 can include a hook, a handle and/or a clip 82 (e.g., a climbing anchor), provided on the enclosure 20, for example, for enabling the load the be connected thereto. More specifically, the user can be provided with a strap 84, such as a nylon runner 85, with a carabiner 86 attached to the device 10 on one end of the strap, and another carabiner attached to the belt loop of a backpack, or a belay seat for more comfort, for example. In situations where multiple loads need to be hoisted, each other person or object (e.g., supplies) can also be attached directly to the device 10 via nylon runners 85 of different lengths. As such, each load would be positioned in a staggered position behind the driver (e.g., the person with the remote control). Alternatively, each subsequent person being hoisted can be connected to the person positioned in front of them, with the first person in line being provided with the remote control, and being connected to the device 10.

The above-described device can be useful in assisting one or more person to be hoisted up an inclined surface, such as a mountainside, in order to reach a desired location, such as a ski lodge, for example. As such, it is appreciated that the hoisting device can be a personal, portable, battery-powered and remote operated ski lift. In some implementations, locations, such as ski resorts, can install a plurality of cables (e.g., between 2 mm and 5 mm dyneema core ropes) anchored to posts, poles, trees or other structures at elevated locations on a mountain. Skiers and snowboarders can find one of these cables, wrap a portion thereof around the drum of the device (if not already done by the resort), connect themselves to the device and activate it. They will then be hoisted along the cable up to the location the cable is anchored. The cable can be inserted in the device at any place along the cable, whereas the cable is wrapped around the drum a few times (e.g., 6 to 10 times) then inserted in the self tailing jaw. With a manually triggered remote controller (e.g., thumb triggered, or index throttled), the driver can accelerate and decelerate the speed of the drum and jaw. Hence, the driver controls the device's speed at a distance.

In other implementations, the cable can be anchored at both ends thereof (e.g., at a starting location and at the destination location). The device can initially be at the starting location, enabling a user (e.g., a skier) to hook themselves up to the device (e.g., via the latching mechanism), and activate the device to be hoisted to their desired location. In such embodiments, the device can be adapted or programmed to autonomously return to the starting location once the hoisted user(s) reach their destination. For example, the person or people who have been hoisted can send a signal to the device (e.g., by pressing a button on the device and/or via the remote control) to send the device back down the cable to allow a separate person or group of people to be hoisted. It is noted that in this implementations (i.e., with the cable being anchored at both ends), the cable can be pre-tensioned between the anchoring points (e.g., trees, poles, posts, etc.) such that the self-tailing winch portion of the device is optional and can be removed. Since the cable remains tensioned from beginning to end without the use of the winch mechanism, the device can be configured to pull the user up the mountainside and along the cable without needing to maintain the cable tensioned in front of the user.

The device can also be used for other purposes, such as tow-in skiing. In areas where the slope would be skiable but where the terrain is not steep enough to gather the speed required to have an enjoyable run, the device can be strapped to a tree and used to propel the riders into the terrain at the required speed. The remote controller makes this possible and easy—once the rider gains an appropriate speed, he or she drops the handle (linked with a rope to the device), puts the remote control in a pocket and drops in the desired terrain at an appropriate or desired speed to enjoy an otherwise unskiable or very boring run. In yet other implementations, it is appreciated that the device can be used for other applications, such as rescue operations, where supplies need to be hoisted up a mountain, or lowered down for crevasse rescue. Other recreational and/or practical applications are possible, such as uphill ziplining and river crossing, among others.

As may now be better appreciated, the present device provides several advantages over conventional devices and/or apparatus in that the hoisting device is portable, lightweight, adapted to fit inside a bag, such as a backpack, is battery-powered and is remotely operable. The aspects of the present disclosure may be embodied in other specific forms without departing from the subject matter of the claims. The described example embodiments are to be considered in all respects as being only illustrative and not restrictive.

The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

In the above description, an embodiment is an example or implementation of the inventions. The various appearances of “one embodiment,” “an embodiment” or “some embodiments” do not necessarily all refer to the same embodiments. Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. Although various features of the invention may be described in the context of a single embodiment, the features may also be provided separately or in any suitable combination. Conversely, although the invention may be described herein in the context of separate embodiments for clarity, the invention may also be implemented in a single embodiment.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

In the above description, the same numerical references refer to similar elements. In addition, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Furthermore, although the various exemplary embodiments described herein may be used in relation with a hoisting device and related system adapted to assist a person in climbing a mountain, for example, it is understood that it may be used for other purposes. For this reason, the term “hoisting device” as used herein should not be taken as to limit the scope of the present disclosure as being used for assisting a person climbing a mountain, or reaching an elevated location. It should be understood that the term “hoisting device” should, in the context of the present disclosure, encompass all other types of arrangements, systems, configurations and purposes with which the described embodiments could be used and may be useful.

Moreover, in the context of the present disclosure, the expressions “device”, “hoist”, “gadget”, “lift”, “attachment”, “extension”, “article”, “accessory”, “assembly”, “apparatus”, “product”, “unit”, “equipment”, “tool”, “method” and “kit”, as well as any other equivalent expression(s) and/or compound word(s) thereof known in the art will be used interchangeably, as apparent to a person skilled in the art. This applies also for any other mutually equivalent expressions, such as, for example: a) “hoisting”, “raising”, “lifting”, “displacing”, etc.; b) “distance”, “position”, “location”, etc.; c) “fastening”, “securing”, “locking”, “restraining”, “affixing”, “holding”, “connecting”, “coupling”, etc.; as well as for any other mutually equivalent expressions, pertaining to the aforementioned expressions and/or to any other structural and/or functional aspects of the present invention, as also apparent to a person skilled in the art. Also, in the context of the present description, expressions such as “can”, “may”, “might”, “will”, “could”, “should”, “would”, etc., may also be used interchangeably, whenever appropriate, as also apparent to a person skilled in the art.

Furthermore, in the context of the present description, it will be considered that all elongated objects will have an implicit “longitudinal axis” or “centerline”, such as the longitudinal axis of a shaft for example, or the centerline of a gear such as a gear used as part of a gearbox, for example, and that expressions such as “connected” and “connectable”, “secured” and “securable”, “engaged” and “engageable”, “installed” and “installable” or “mounted” and “mountable”, may be interchangeable, in that the present hoisting system or hoisting device also relates to kits with corresponding components for assembling a resulting fully-assembled and fully-operational hoisting system or hoisting device.

Moreover, components of the present hoisting device system(s) and/or steps of the method(s) described herein could be modified, simplified, altered, omitted and/or interchanged, without departing from the scope of the present invention, depending on the particular applications which the present invention is intended for, and the desired end results, as briefly exemplified herein and as also apparent to a person skilled in the art.

In addition, although the optional configurations as illustrated in the accompanying drawings comprise various components and although the optional configurations of the disclosed device as shown may consist of certain configurations as explained and illustrated herein, not all of these components and configurations are essential and thus should not be taken in their restrictive sense, i.e. should not be taken as to limit the scope of the present disclosure. It is to be understood that other suitable components and cooperations thereinbetween, as well as other suitable configurations may be used for the hoisting device, and corresponding parts, as briefly explained, and as can be easily inferred herefrom, without departing from the scope of the disclosure.

To provide a more concise description, some of the quantitative and qualitative expressions understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value given herein may be qualified with the terms “about”, “generally” and “substantially”.

1. A portable hoisting device configured to be connected to a cable secured to a destination location for hoisting at least one person from a start location to the destination location, comprising:
an enclosure;
a drum assembly rotatably mounted to the enclosure and comprising:
a drum body having an elongated portion shaped and adapted to have the cable wrap around the drum body; and
a drum head mounted to the drum body opposite the enclosure, the drum head having a tensioning mechanism adapted to maintain the second end of the cable under tension;
a gear train at least partially housed within the enclosure and the drum body, and comprising a transmission gear operatively connected to the drum body and operable to engage the drum body in rotation for wrapping and unwrapping the cable from the drum body;
a motor operatively connected to the gear train to engage the transmission gear in rotation;
a control assembly operatively connected to the motor to control same;
a latching assembly adapted to enable the at least one person to be connected to the enclosure, wherein rotation of the drum assembly wraps a first end of the cable around the drum body and unwraps and pays out a second end of the cable for hoisting the at least one person toward the destination location.

2. The portable hoisting device of claim 1, wherein the control assembly comprises an electronic speed controller (ESC) operatively connected to the motor for controlling same, and a power source operatively connected to the ESC to supply power thereto and being in data communication with a command transceiver to receive a control signal therefrom.

3. The portable hoisting device of claim 2, wherein the power source is a battery pack.

4. The portable hoisting device of claim 2 or 3, wherein the control assembly comprises a remote control configured to send signals to the command transceiver and control the ESC remotely.

5. The portable hoisting device of any one of claims 1 to 4, wherein the control assembly is connectable to the motor via wires.

6. The portable hoisting device of claim 3, further comprising a control assembly compartment adapted to house at least one of the battery pack, the ESC and the remote control, and wherein the control assembly compartment is adapted to be transported by or on the person to enable remote operation of the motor.

7. The portable hoisting device of claim 6, wherein the control assembly further comprises a battery management system (BMS) provided within the control assembly compartment and configured to monitor the state of the battery pack.

8. The portable hoisting device of claim 7, wherein the BMS is configured to monitor at least one of a voltage, a current, a temperature and a coolant flow.

9. The portable hoisting device of any one of claims 1 to 8, wherein the battery pack comprises at least one of a 4S battery, a 6S battery, 12S battery, a 18S battery or a combination thereof.

10. The portable hoisting device of any one of claims 1 to 9, wherein the motor has a KV output of between about 50 KV and about 250 KV.

11. The portable hoisting device of any one of claims 1 to 10, wherein the enclosure comprises a shaft, and wherein the drum body comprises a drum body shell having a bore therethrough for receiving the shaft, and wherein the cable is adapted to be wrapped around the drum shell.

12. The portable hoisting device of claim 11, wherein the drum body shell comprises a bottom end operatively coupled to the gear train, and a top end opposite the bottom end, and wherein the drum body shell is shaped and adapted to prevent the portion of cable wrapped around it from being released through the bottom end and the top end thereof.

13. The portable hoisting device of claim 12, wherein the gear train comprises a plurality of transmission gears adapted to define a planetary gear assembly, and wherein the bottom end of the drum body shell comprises an internal gear configured to engage the planetary gear assembly.

14. The portable hoisting device of any one of claims 1 to 13, wherein the gear train comprises a pair of driver gears coupled to the transmission gear, and wherein the motor comprises a pair of driving motors operatively connected to the driver gears.

15. The portable hoisting device of any one of claims 1 to 14, wherein the gear train defines a gear ratio between about 4:1 and about 25:1.

16. The portable hoisting device of any one of claims 1 to 15, wherein the latching assembly comprises a clip secured to the enclosure or drum body, the clip being adapted to have a strap attached thereto, the strap having a free end adapted to be attached to the person.

17. A portable hoisting device configured to be connected to a cable, comprising:
a winch mechanism having a drum body being shaped and adapted to have a portion of the cable wrap around the drum body, the winch mechanism being operable to selectively wrap the cable around the drum body;
a gear train comprising a transmission gear operatively connected to the drum body and operable to engage the drum body in rotation;
a motor operatively connected to the gear train to engage the transmission gear in rotation;
a control assembly operatively connected to the motor to control same; and
a latching assembly adapted to enable a load to be connected to a component of the portable hoisting device,
wherein the control assembly comprises a remote control configured to send signals to the motor remotely.

18. The portable hoisting device of claim 18, wherein the power source is a battery pack.

19. The portable hoisting device of claim 18 or 19, wherein the control assembly is connectable to the motor via wires.

20. The portable hoisting device of any one of claims 18 to 20, wherein the winch mechanism is a self-tailing winch mechanism operable to feed a first end of the cable to the drum body and simultaneously pay out a second end of the cable.
